(19) United States
(12) Patent Application Publication
(10) Pub. No.: US 2013/0130727 A1
(43) Pub. Date: May 23, 2013

(54) METHOD AND APPARATUS FOR UTILIZING DISCOVERY SIGNALS

(71) Applicants: Sami-Jukka Hakola, Kempele (FI); Samuli Turtinen, Ii (FI); Timo Koskela, Oulu (FI)

(72) Inventors: Sami-Jukka Hakola, Kempele (FI); Samuli Turtinen, Ii (FI); Timo Koskela, Oulu (FI)

(73) Assignee: RENESAS MOBILE CORPORATION, Tokyo (JP)

(21) Appl. No.: 13/307,895

(22) Filed: Nov. 30, 2011

(30) Foreign Application Priority Data
Nov. 17, 2011 (GB) 1119880.1

(51) Int. Cl. H04W 68/00

(52) U.S. Cl. 455/458

(57) ABSTRACT

A method, apparatus and computer program product are provided to efficiently establish communications regardless of the radio resource control (RRC) state of the device that issues the discovery signal. In regards to a method, a cell identification and/or tracking area code is associated with a discovery signal. Thereafter, the method causes a discovery signal to be transmitted to discover another device with which to establish communications. The method also receives a paging signal in response to the discovery signal and causes communications to be established in response to the paging signal. By associating a cell identification and/or a tracking area code with at least part of the discovery signal, the paging signals may be focused in the cell and/or tracking area in which the device that issued the discovery signal is located, even when the device is in an RRC Idle state.

### CROSS-REFERENCE TO RELATED APPLICATION

This application claims the benefit of and priority to United Kingdom patent application number 1119880.1, filed on Nov. 17, 2011.

### TECHNOLOGICAL FIELD

An example embodiment of the present invention relates generally to the establishment of communication and, more particularly, to the paging that is performed in order to establish communication.

### BACKGROUND

Device to device communication allows for two or more devices to communicate directly with one another. Device to device communication has gained popularity and is expected to significantly increase in the near future.

In order to establish device to device communication, a first device, such as a mobile terminal or other user equipment (UE), may transmit a discovery signal. The discovery signal provided by the first device may include the device identity, the application identity, a radio identifier, such as the cell radio network temporary identifier (C-RNTI), the service type, etc. The discovery signal may be received by one or more devices in the proximity of the first device. In an instance in which one of the devices that receives the discovery signal desires to establish device to device communications with the first device, the device that receives the discovery signal may communicate with the network and the network may, in turn, page the first device. In response to the paging signals issued by the network, the first device may respond and, in turn, device to device communications may be established.

In an instance in which the first device is in a radio resource control (RRC) Connected state at the time of the issuance of the discovery signal, the network is generally able to determine the cell that is currently serving the first device that transmitted the discovery signal. As such, the network may efficiently establish communications with the first device without having to search for the first device by, for example, issuing paging signals in cells in which the first device is not located, thereby allowing for more efficient network utilization by avoiding the unnecessary consumption of network resources in cells that are not serving the first device.

In an instance in which the first device that issues the discovery signal is not in an RRC Connected state, but is, instead, in an RRC Idle state, the network will not generally be aware of the cell in which the first device is located. As such, the network may transmit paging signals across a broader expanse of the network in an effort to locate the first device, thereby consuming additional network resources. For example, the network may issue paging signals from each of the base stations within the tracking areas in the tracking area list of the first device as configured by the mobility management entity (MME). In this instance, the network must issue paging signals across a greater portion of the network, thereby consuming additional network resources in an effort to establish device to device communication while the first device is in an RRC Idle state.

### BRIEF SUMMARY

A method, apparatus and computer program product are therefore provided according to an example embodiment of the present invention to provide a more efficient mechanism by which communications, such as device to device communications, may be established regardless of the RRC state of the device that issues the discovery signal. For example, the method, apparatus and computer program product of one embodiment may facilitate the efficient establishment of communications, such as device to device communications, in an instance in which the device issuing the discovery signal is in an RRC Idle state. In this regard, the method, apparatus and computer program product of one example embodiment of the present invention may cause the paging signals issued by the network to be more tightly focused or limited, even in an instance in which the device issuing the discovery signal is in an RRC idle state, thereby conserving network resources while still providing for the reliable establishment of communications, such as device to device communications.

A method is provided in one embodiment that includes associating at least one of a cell identification or a tracking area code with a discovery signal. Subsequent to the associating, the method causes a discovery signal to be transmitted in association with at least one of the cell identification or the tracking area code in order to discover another device with which to establish communications. The method also receives a paging signal in response to the discovery signal and causes communications to be established with another device in response to the paging signal.

In another embodiment, an apparatus is provided that includes at least one processor and at least one memory including computer program code with the at least one memory and the computer program code being configured to, with at least one processor, cause the apparatus to at least associate at least one of a cell identification or a tracking area code with a discovery signal. The at least one memory and the computer program code are also configured to, with at least one processor, cause the apparatus to cause a discovery signal to be transmitted, subsequent to the associating, in association with at least one of the cell identification or the tracking area code in order to discover another device with which to establish communications. The at least one memory and the computer program code are also configured to, with the at least one processor, cause the apparatus to receive a paging signal in response to the discovery signal and to cause communications to be established with another device in response to the paging signal.

In a further embodiment, a computer program product is provided that includes at least one non-transitory computer-readable storage medium having computer-readable program instructions stored therein with the computer-readable program instructions including program instructions configured to associate at least one of a cell identification or a tracking area code with a discovery signal. The computer-readable program instructions may also include program instructions configured, subsequent to the associating, to cause a discovery signal to be transmitted in association with at least one of the cell identification or the tracking area code in order to discover another device with which to establish communications. The computer-readable program instructions may also include program instructions configured to receive a paging signal in response to the discovery signal and program instructions configured to cause communications to be established with another device in response to the paging signal.

In yet another embodiment, an apparatus is provided that includes means for associating at least one of a cell identification or a tracking area code with a discovery signal. The apparatus of this embodiment also includes means for causing the discovery signal to be transmitted, subsequent to the associating, in association with at least one of the cell identification or the tracking area code in order to discover another device with which to establish communications. The apparatus of this embodiment also includes means for receiving a paging signal in response to the discovery signal and means for causing communications to be established with another device in response to the paging signal.

In one embodiment, a method is provided that includes receiving a discovery signal from another device that seeks to establish communications. The method also determines whether a predetermined cell identification or a predetermined tracking area code is associated with the discovery signal. In an instance in which the discovery signal is associated with a predetermined cell identification or predetermined tracking area code, the method also causes the predetermined cell identification or the predetermined tracking area code to be provided to a network to facilitate paging of another device. The method of this embodiment also causes communications to be established with another device in response to the paging.

In another embodiment, an apparatus is provided that includes at least one processor and at least one memory including computer program code with the at least one memory and the computer program code being configured to, with the at least one processor, cause the apparatus to at least receive a discovery signal from another device that seeks to establish communications. The at least one memory and the computer program code are also configured to, in response to the at least one processor, cause the apparatus to determine whether a predetermined cell identification or a predetermined tracking area code is associated with the discovery signal. In an instance in which the discovery signal is associated with a predetermined cell identification or a predetermined tracking area code, the at least one memory and the computer program code are configured to, with the at least one processor, cause the apparatus to cause the predetermined cell identification or the predetermined tracking area code to be provided to a network entity to facilitate paging of another device. The at least one memory and the computer program code are also configured to, with the at least one processor, cause the apparatus to cause communications to be established with another device in response to the paging.

In a further embodiment, a computer program product is provided that includes at least one non-transitory computer-readable storage medium having computer-readable program instructions stored therein with the computer-readable program instructions including program instructions configured to receive a discovery signal from another device that seeks to establish communications. The computer-readable program instructions also include program instructions configured to determine whether a predetermined cell identification or a predetermined tracking area code is associated with the discovery signal. In an instance in which the discovery signal is associated with a predetermined cell identification or predetermined tracking area code, the computer-readable program instructions also include program instructions configured to cause the predetermined cell identification or the predetermined tracking area code to be provided to a network to facilitate paging of another device. The computer-readable program instructions also include program instructions configured to cause communications to be established with another device in response to the paging.

In yet another embodiment, an apparatus is provided that includes means for receiving a discovery signal from another device that seeks to establish communications. The apparatus also includes means for determining whether a predetermined cell identification or a predetermined tracking area code is associated with the discovery signal. In an instance in which the discovery signal is associated with a predetermined cell identification or a predetermined tracking area code, the apparatus of this embodiment also includes means for causing the predetermined cell identification or the predetermined tracking area code to be provided to a network entity to facilitate paging of another device. The apparatus of this embodiment also includes means for causing communications to be established with another device in response to the paging.

### BRIEF DESCRIPTION OF THE SEVERAL VIEWS OF THE DRAWINGS

Having thus described several example embodiments of the invention in general terms, reference will now be made to the accompanying drawings, which are not necessarily drawn to scale, and wherein:

FIG. 1 is a schematic representation of a system for utilizing discovery signals to facilitate paging in accordance with an example embodiment of the present invention;

FIG. 2 is a block diagram of an apparatus that may be embodied as a device that is configured to utilize discovery signals to facilitate paging in accordance with an example embodiment of the present invention;

FIG. 3 is a flow chart of the operations performed by an apparatus embodied by a device that issues a discovery signal to establish communications in accordance with one embodiment of the present invention; and

FIG. 4 is a flow chart illustrating operations performed by an apparatus embodied by a device that receives the discovery signal and that responds in order to establish communications in accordance with an example embodiment of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

As used in this application, the term “circuitry” refers to all of the following: (a)hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of “circuitry” applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or application specific integrated circuit for a mobile phone or a similar integrated circuit in server, a cellular network device, or other network device.

A method, apparatus and computer program product are provided in accordance with an example embodiment of the present invention in order to utilize discovery signals in order to facilitate paging, such as during the establishment of communications, e.g., device to device communications, in a manner that conserves network resources. In one embodiment, the method, apparatus and computer program product allow for the efficient establishment of device to device communications regardless of the RRC state of the device that issues the discovery signal, including in an instance in which the device that issues the discovery signal is in an RRC Idle state.

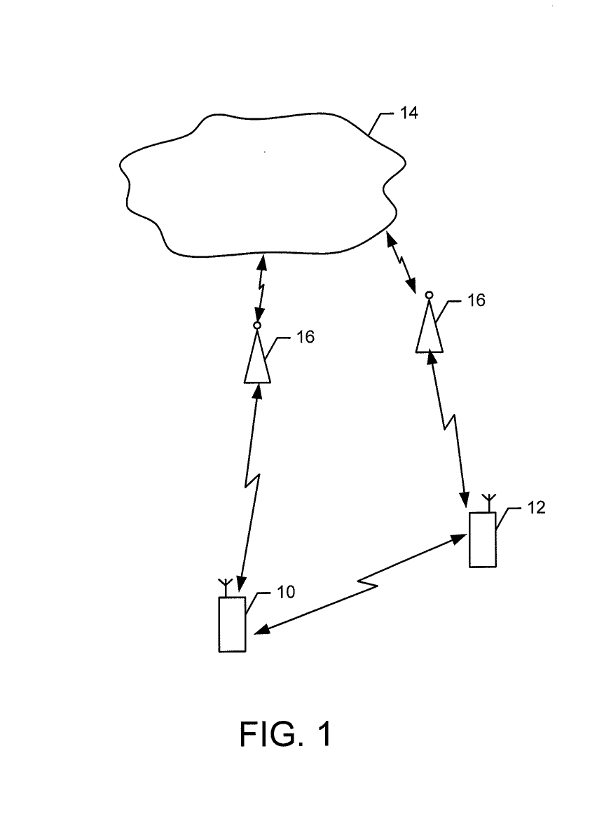

Although the method, apparatus and computer program product may be implemented in a variety of different systems, one example of such a system is shown in FIG. 1, which includes first and second communication devices 10, 12 that are capable of communication with each other via device to device communications. The first and second communication devices may also be configured to communicate with a network 14 (e.g., a core network) via respective network entities 16, such as an access point, e.g., a base station, a Node B, an evolved Node B (eNB), serving cell or other access point. While the network may be configured in accordance with Long Term Evolution (LTE) or LTE-Advanced (LTE-A), other networks may support the method, apparatus and computer program product of embodiments of the present invention including those configured in accordance with wideband code division multiple access (W-CDMA), CDMA2000, global system for mobile communications (GSM), general packet radio service (GPRS) and/or the like.

The network 14 may include a collection of various different nodes, devices or functions that may be in communication with each other via corresponding wired and/or wireless interfaces. For example, the network may include one or more cells, supported by respective access points, each of which may serve a respective coverage area. The cells could be, for example, part of one or more cellular or mobile networks or public land mobile networks (PLMNs). In turn, other devices such as processing devices (e.g., personal computers, server computers or the like) may be coupled to the communication devices 10, 12 via the network.

A communication device 10, 12, such as the mobile terminal (also known as user equipment (UE)), may be in communication with other communication devices or other devices via either device to device communications or via the network 14 utilizing, for example, an access point 16. In some cases, the communication device may include an antenna for transmitting signals to and for receiving signals from a serving cell.

In some example embodiments, the communication device 10, 12 may be a mobile terminal such as, for example, a mobile telephone, portable digital assistant (PDA), pager, laptop computer, or any of numerous other hand held or portable communication devices, computation devices, content generation devices, content consumption devices, or combinations thereof. As such, the communication device 10, 12 may include one or more processors that may define processing circuitry either alone or in combination with one or more memories. The processing circuitry may utilize instructions stored in the memory to cause the communication device 10, 12 to operate in a particular way or execute specific functionality when the instructions are executed by the one or more processors. The communication device 10, 12 may also include communication circuitry and corresponding hardware/software to enable communication with other devices and/or the network 14.

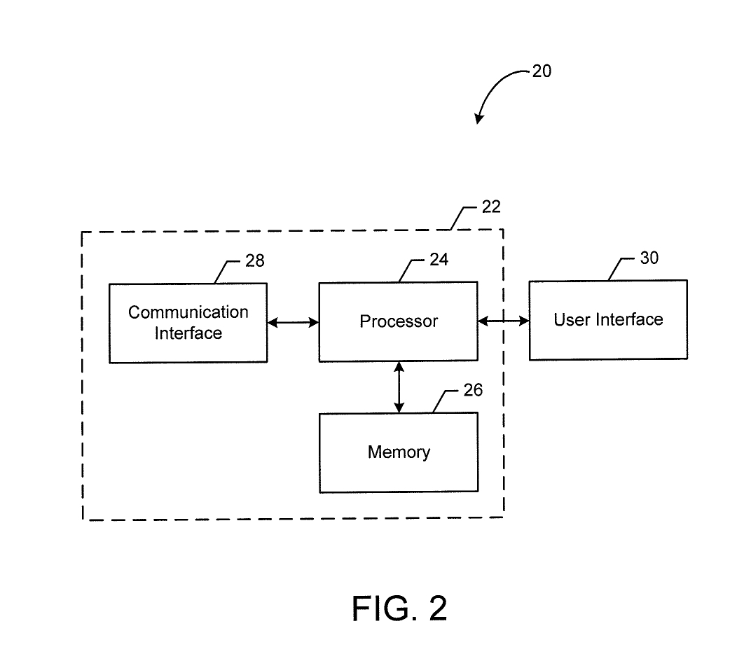

In one embodiment, for example, either or both of the communication devices 10, 12 may be embodied as or otherwise include an apparatus 20 as generically represented by the block diagram of FIG. 2. While the apparatus 20 may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 2, the apparatus 20 may include or otherwise be in communication with processing circuitry 22 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 22 may include a processor 24 and memory 26 that may be in communication with or otherwise control a communication interface 28 and, in some cases, a user interface 30. As such, the processing circuitry may be embodied as a circuit chip (e.g., an integrated circuit chip) configured (e.g., with hardware, software or a combination of hardware and software) to perform operations described herein. However, in some embodiments taken in the context of the communication device 10, 12, the processing circuitry may be embodied as a portion of a mobile computing device or other mobile terminal.

The user interface 30 (if implemented) may be in communication with the processing circuitry 22 to receive an indication of a user input at the user interface and/or to provide an audible, visual, mechanical or other output to the user. As such, the user interface may include, for example, a keyboard, a mouse, a joystick, a display, a touch screen, a microphone, a speaker, and/or other input/output mechanisms.

The communication interface 28 may include one or more interface mechanisms for enabling communication with other devices and/or networks. In some cases, the communication interface may be any means such as a device or circuitry embodied in either hardware, or a combination of hardware and software that is configured to receive and/or transmit data from/to a network 14 and/or any other device or module in communication with the processing circuitry 22, such as between the communication devices 10, 12 via device to device communication or via the network, such as a cellular, e.g., LTE, network. In this regard, the communication interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 26 may include one or more non-transitory memory devices such as, for example, volatile and/or non-volatile memory that may be either fixed or removable. The memory may be configured to store information, data, applications, instructions or the like for enabling the apparatus 20 to carry out various functions in accordance with example embodiments of the present invention. For example, the memory could be configured to buffer input data for processing by the processor 24. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 24 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 26 or otherwise accessible to the processor. As such, whether configured by hardware or by a combination of hardware and software, the processor may represent an entity (e.g., physically embodied in circuitry—in the form of processing circuitry 22) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

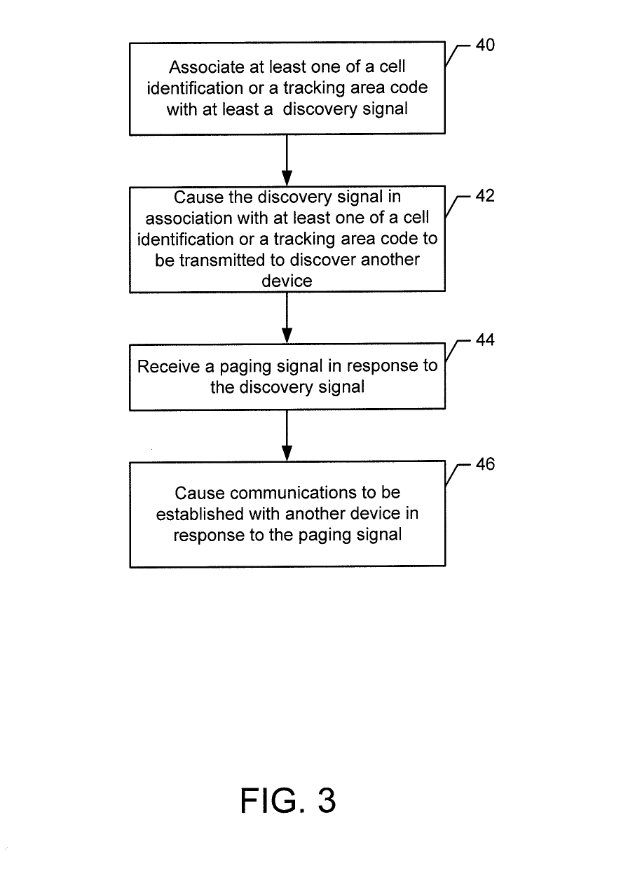

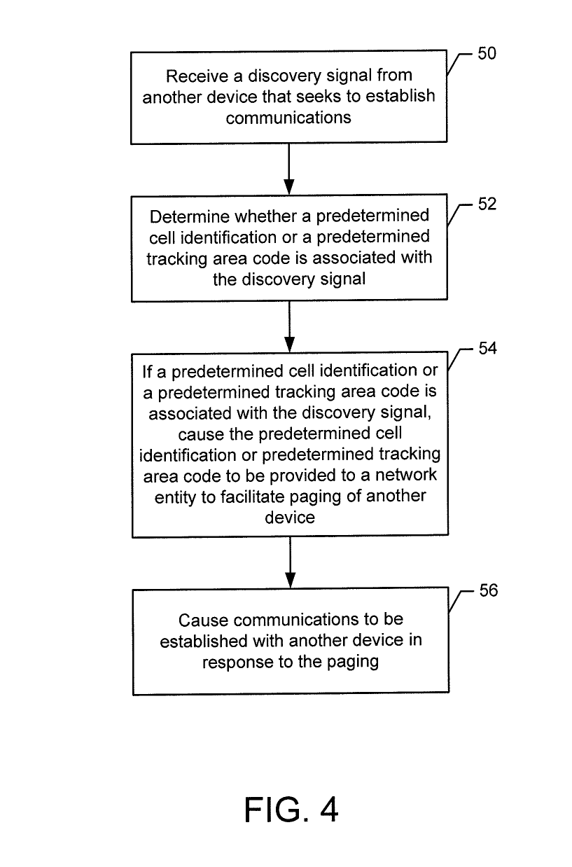

FIGS. 3 and 4 are flowcharts illustrating the operations performed by a method, apparatus and computer program product, such as apparatus 20 of FIG. 2, from the perspective of a communications device 10 that issues a discovery signal in the context of FIG. 3 and a communications device 12 that receives and responds to the discovery signal in the context of FIG. 4 in accordance with one embodiment of the present invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device 26 of an apparatus employing an embodiment of the present invention and executed by a processor 24 in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s). As such, the operations of FIGS. 3 and 4, when executed, convert a computer or processing circuitry into a particular machine configured to perform an example embodiment of the present invention. Accordingly, the operations of FIGS. 3 and 4 define an algorithm for configuring a computer or processing circuitry 22, e.g., processor, to perform an example embodiment. In some cases, a general purpose computer may be provided with an instance of the processor which performs the algorithm of FIGS. 3 and 4 to transform the general purpose computer into a particular machine configured to perform an example embodiment.

Accordingly, blocks of the flowcharts support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein.

Referring now to FIG. 3, the operations performed by a method, apparatus and computer program product of an example embodiment are illustrated from the perspective of a first communications device 10 (also referred to as the “first device”) that causes a discovery signal to be transmitted, such as to establish communications, e.g., device to device communications. In accordance with an example embodiment, information may be associated with the discovery signal that permits the first device that transmits the discovery signal to be located, such as within a tracking area, within a cell or the like. As such, the network 14 may page the first device in a more focused and efficient manner in order to establish communications, such as device to device communications.

While information may be associated with the discovery signal in order to permit the first device 10 to be located regardless of the RRC state of the first device 10, the association of information that permits the first device to be located with the discovery signal is particularly advantageous in an instance in which the first device is not in an RRC Connected state, such as in an instance in which the first device is in an RRC Idle state. In an instance in which the first device is in an RRC Idle state, the first device has a valid internet protocol (IP) address, has been authenticated and has a security context that is stored in the MME. As such, the RRC Idle state provides a power efficient state for low duty cycle discovery and service advertisement signaling by the communication devices 10, 12 while being authenticated by the network 14, which should allow autonomous signal transmission on certain resources. However, the network 14 has less information regarding the relative location of the first device while the first device is in an RRC Idle state then while the device is in an RRC Connected state. Thus, greater advantages may be provided in terms of focusing the network paging by an example embodiment of the present invention in an instance in which the first device that issues the discovery signal is in an RRC Idle state since the network would otherwise issue the paging signals on a relatively broad basis, thereby consuming substantially more network resources than would be desired in order to establish the device to device communications.

As shown in block 40 of FIG. 3, the apparatus 20 embodied by the first device 10 that issues the discovery signal may include means, such as the processing circuitry 22, the processor 24 or the like, for associating at least one of a cell identification or a tracking area code with the discovery signal. The cell identification and/or the tracking area code may be associated with the discovery signal in various manners. In one embodiment, at least a portion of the discovery signal is masked with at least one of the cell identification or the tracking area code. While the apparatus of this embodiment, such as the processing circuitry or the processor, may mask the entire discovery signal or a portion of the discovery signal with at least one of a cell identification or tracking area code, the apparatus, such as the processing circuitry or the processor, of one embodiment may be configured to mask the cyclic redundancy code (CRC) of the discovery signal with at least one of the cell identification or the tracking area code. In another embodiment, the cell identification and/or the tracking area code is associated with the discovery signal by including the cell identification and/or the tracking area code as data that is transmitted along with and/or as part of the discovery signal.

In regards to masking at least a portion of the discovery signal with the cell identification and/or the tracking area code, at least a portion of the discovery signal may be masked with the cell identification and/or the tracking area code itself. However, masking at least a portion of the discovery signal with the cell identification and/or the tracking area code also includes masking at least a portion of the discovery signal with a masking sequence that is derived from or otherwise based upon or associated with the cell identification and/or the tracking area code. For example, in an embodiment in which the CRC of the discovery signal is to be masked with the cell identification, the CRC of the discovery signal may be masked with a masking sequence that is associated with one of the three primary synchronization signals (PSS) that comprise the physical cell identification. By way of example, masking sequences of <0,0,0,0,0,0,0,0,0,0,0,0,0,0,0,0,0,0,0,0>, <1,1,1,1,1,1,1,1,1,1,1,1,1,1,1,1,1,1,1,1> and <0,1,0,1,0,1,0,1,0,1,0,1,0,1,0,1,0,1,0,1> may be associated with PSS1, PSS2 and PSS3, respectively.

In an embodiment in which the apparatus 20, such as the processing circuitry 22 or the processor 24, is configured to associate the cell identification, that is, with an identification of the cell within which the first device 10 is located, with the discovery signal, such as by masking the CRC of the discovery signal with the cell identification, the apparatus, such as the processing circuitry or the processor, may associate the physical cell identity or at least a portion of the physical cell identity of the cell within which the first device is located with the discovery signal. For example, the apparatus, such as the processing circuitry or the processor, of this embodiment may associate at least one of the primary synchronization signals of the cell in which the first device is located with the discovery signal, such as by masking the CRC of the discovery signal with at least one of the primary synchronizations signals.

In another embodiment, the apparatus 20, such as the processing circuitry 22 or the processor 24, may be configured to associate the tracking area code of the tracking area within which the first device 10 is located with the discovery signal, such as by masking the CRC of the discovery signal with the tracking area code. In yet another embodiment, the apparatus, such as the processing circuitry or the processor, may be configured to associate both the cell identification and the tracking area code associated with the first device with the discovery signal. In this embodiment, one of the cell identification or the tracking area code may be utilized to mask at least a portion of the discovery signal, such as the CRC, while the other of the cell identification or the tracking area code may be included as data with the discovery signal. Alternatively, the same portion of the discovery signal, such as the CRC, may first be masked with one of the cell identification or the tracking area code and may then be subsequently masked again with the other of the cell identification or the tracking area code. As yet another embodiment, different portions of the discovery signal may be masked with the cell identification and the tracking area code.

Following the association of at least one of the cell identification or the tracking area code with the discovery signal, the apparatus 20 embodied by the first device 10 may include means, such as the processing circuitry 22, the processor 24, the communication interface 28 or the like, for causing the discovery signal to be transmitted in association with at least one of the cell identification or the tracking area code in an effort to identify or otherwise discover another device, such as another device with which to establish communications, e.g., device to device communications. See block 42 of FIG. 3. Following the reception of this discovery signal by another device, e.g., communication device 12, and the subsequent request by the other device for the network 14 to page the first device, such as to establish communications, e.g., device to device communications, as will be described hereinafter, the apparatus embodied by the first device may also include means, such as the processing circuitry, the processor, the communication interface or the like, for receiving a paging signal in response to the discovery signal. See block 44. In this regard, the paging signal may be received from the network, such as from a network entity 16, e.g., an access point. In one embodiment, the paging signal may provide the first device with the necessary information in order to establish communications, such as device to device communications, with the other device responsive to the discovery signal. Thereafter, the apparatus embodied by the first device may include means, such as the processing circuitry, the processor, the communication interface or the like, for causing communications to be established with the other device in response to the paging signal. See block 46. Various types of communications may be established between the devices including device to device communication or network communication, such as cellular communications in an instance in which the devices are in communication with a cellular, e.g., LTE, network.

As will be described below, the paging signals issued by the network 14 may be more particularly focused, even in instances in which the first device 10 is in an RRC Idle state so as to provide for more efficient network utilization, such as during the establishment of communications. In this regard and as will also be described below, the paging may be limited to the cell and/or the tracking area that was identified by the cell identification or the tracking area code with which the discovery signal was masked. Accordingly, the paging signals are transmitted in the area in which the first device is located without having to transmit paging signals in other areas in which the first device is not located and which would otherwise unnecessarily consume network resources.

From the perspective of the communication device 12 that receives the discovery signal and that desires to establish communications, such as device to device communications, with the first device 10, block 50 of FIG. 4 illustrates that the apparatus 20 embodied by the other device includes means, such as the processing circuitry 22, the processor 24, the communication interface 28 or the like, for receiving a discovery signal from the first device that seeks, for example, to establish communications. In accordance with an example embodiment of the present invention, the apparatus embodied by the other device also includes means, such as the processing circuitry, the processor or the like, for determining whether a predetermined cell identification or a predetermined tracking area code is associated with the discovery signal. See block 52 of FIG. 4.

As described above, the predetermined cell identification and/or the predetermined tracking area code may be associated with the discovery signal in various manners. For example, at least a portion of the discovery signal, such as the CRC of the discovery signal, may be masked with the predetermined cell identification and/or the predetermined tracking area code. Alternatively, the predetermined cell identification and/or the predetermined tracking area code may be included as data that is received with the discovery signal.

In one embodiment, the apparatus 20 embodied by the other device 12, such as the processing circuitry 22, the processor 24 or the like, may therefore be configured to determine whether at least a portion of the discovery signal is masked with the predetermined cell identification and/or the predetermined tracking area code. In order to determine whether at least a portion of the discovery signal is masked, at least a portion of the discovery signal, such as the CRC, may be de-masked or otherwise processed in order to determine what, if any, code or other information was utilized to mask the respective portion of the discovery signal. In another embodiment, the apparatus, such as the processing circuitry, the processor or the like, may be configured to determine whether the predetermined cell identification and/or the predetermined tracking area code is included as data that was received as part of or along with the discovery signal.

In order to recognize the cell identification and/or tracking area code that is associated with the discovery signal, the apparatus 20 embodied by the other device 12 may include means, such as the processing circuitry 22, the processor 24, the memory 26 or the like, for storing one or more cell identifications of cells that have been determined by the other device to be proximate to or otherwise in the vicinity of the other device. Additionally or alternatively, the apparatus embodied by the other device may include means, such as the processing circuitry, the processor, the memory or the like, for storing one or more tracking area codes that have been determined by the other device to be proximate to or otherwise in the vicinity of the other device. In these embodiments, the apparatus, such the processing circuitry, the processor or the like, may determine if one or more of the predetermined cell identifications and/or one or more of the predetermined tracking area codes that are stored by the other device are associated with the discovery signal.

In an instance in which a predetermined cell identification or a predetermined tracking area code that are stored by the other device 12 are not associated with the discovery signal, the other device may not respond to the discovery signal, thereby not establishing communications, e.g., device to device communications, with the first device 10 since the first device may be located in a cell or tracking area that is more remote from or otherwise has poor communication with the other device. However, in an instance in which the apparatus 20, such as the processing circuitry 22, the processor 24 or the like, determines that a predetermined cell identification or a predetermined tracking area code that is stored by the other device is associated with the discovery signal, the apparatus embodied by the other device may include means, such as the processing circuitry, the processor, the communication interface 28 or the like, for causing the predetermined cell identification or the predetermined tracking area code with which the discovery signal is associated to be provided to a network entity 16, such as an access point or the like, to facilitate paging of the first device. See block 54 of FIG. 4. In this regard, the network 14 may receive the predetermined cell identification or the predetermined tracking area code that is associated with the discovery signal and may cause one or more paging signals to be transmitted.

In an instance in which a predetermined cell identification is associated with the discovery signal, the network 14 may cause the paging signals to be transmitted within the predetermined cell, but not other predetermined cells. Additionally or alternatively, in an instance in which a predetermined tracking area code is associated with the discovery signal, the network may cause the paging signals to be transmitted within the predetermined tracking area, but not within other tracking areas. Still further, in an instance in which both a predetermined cell identification and a predetermined tracking area code are associated with the discovery signal, the network may cause the paging signals to be issued within that region that satisfies both the predetermined cell and the predetermined tracking area, that is, that region that is both within the predetermined cell and within the predetermined tracking area. In any instance, the method, apparatus 20 and computer program product allows for a more focused transmission of the paging signals, even in an instance in which the first device 10 that issued the discovery signals is not in a RRC Connected state, such as in an instance in which the first device is in a RRC Idle state such that the network otherwise does not know the location of the first device with specificity.

In response to the paging signal, the communication devices 10, 12 may take various actions. For example, communications may be established between the devices, such as device to device communications or network communications, such as via a cellular network. In one embodiment and in response to receipt of the paging signals, the first device 10 may then proceed with the establishment of communications, such as device to device communications, with the other device 12. In this regard, the apparatus 20 embodied by the other device may also include means, such as the processing circuitry 22, the processor 24, the communication interface 28 or the like, may also cause communications, such as device to device communications, to be established with the first device in response to the paging. See block 56 of FIG. 4. As noted above, however, the establishment of the communications may have been performed in an efficient manner from the standpoint of the network resources that were utilized since the paging signals issued by the network 14 in order to establish the communications may be focused within the cell and/or tracking area within which the first device is located as opposed to being more broadly transmitted, particularly in instances in which the first device is in an RRC Idle state such that the network otherwise does not know the location of the first device with such specificity.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. For example, the second communications device 12 that receives the discovery signal may not be able to identify the cell identification and/or tracking area code that is associated with the discovery signal. For example, the first device 10 may be connected to a femto cell. In an instance in which the other device that receives the discovery signal is connected to another cell, the other device may not have been able to detect the femto cell and the cell identification of the femto cell. However, if the discovery signal is associated with at least a portion of the cell identication, such as a physical layer cell identity of the femto cell, the other device may more efficiently determine the correct value, e.g.,the physical layer identity of the cell that supports the first device, that is associated with the discovery signal, such as the correct value that was utilized to mask at least a portion of the discovery signal. In this regard, the other device may need only to try three times at most to find the correct value, such as by trying each of the three primary synchronization signals associated with the cell identification. The other device may then provide this value to the network 14 in conjunction with a request for a connection setup with the first device, thereby also permitting the network to reduce the paging load in the network by one-third in this example embodiment.

Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A method comprising:
associating, with a processor, at least one of a cell identification or a tracking area code with a discovery signal;
subsequent to the associating, causing the discovery signal in association with at least one of the cell identification or the tracking area code to be transmitted in order to discover another device;
receiving a paging signal from a network entity in response to the discovery signal; and
causing communications to be established with another device in response to the paging signal.

2. A method according to claim 1 wherein associating comprises masking at least a portion of the discovery signal with at least one of the cell identification or the tracking area code.

3. A method according to claim 2 wherein masking at least a portion of the discovery signal comprises masking a cyclic redundancy check of the discovery signal with at least one of the cell identification or the tracking area code.

4. A method according to claim 2 wherein masking at least a portion of the discovery signal comprises masking at least a portion of the discovery signal with a masking sequence associated with at least one of a cell identification or a tracking area code.

5. A method according to claim 1 wherein associating comprises including at least one of the cell identification or the tracking area code as data to be transmitted with the discovery signal.

6. A method according to claim 1 wherein associating comprises associating at least a portion of a physical cell identity with the discovery signal.

7. An apparatus comprising:
at least one processor; and
at least one memory including computer program code, wherein the at least one memory and the computer program code are configured to, with the at least one processor, cause the apparatus to at least:
associate at least one of a cell identification or a tracking area code with a discovery signal;
subsequent to the associating, cause the discovery signal in association with at least one of the cell identification or the tracking area code to be transmitted in order to discover another device;
receive a paging signal from a network entity in response to the discovery signal; and
cause communications to be established with another device in response to the paging signal.

8. An apparatus according to claim 7 wherein the at least one memory and the computer program code are configured to, with the at least one processor, cause the apparatus to associate at least a portion of the discovery signal with at least one of the cell identification or the tracking area code by masking at least a portion of the discovery signal with at least one of the cell identification or the tracking area code.

9. An apparatus according to claim 8 wherein the at least one memory and the computer program code are configured to, with the at least one processor, cause the apparatus to mask at least a portion of the discovery signal by masking a cyclic redundancy check of the discovery signal with at least one of the cell identification or the tracking area code.

10. An apparatus according to claim 8 wherein the at least one memory and the computer program code are configured to, with the at least one processor, cause the apparatus to mask at least a portion of the discovery signal by masking at least a portion of the discovery signal with a masking sequence associated with at least one of a cell identification or a tracking area code.

11. An apparatus according to claim 7 wherein the at least one memory and the computer program code are configured to, with the at least one processor, cause the apparatus to associate at least a portion of the discovery signal with at least one of the cell identification or the tracking area code by including at least one of the cell identification or the tracking area code as data to be transmitted with the discovery signal.

12. An apparatus according to claim 7 wherein the at least one memory and the computer program code are configured to, with the at least one processor, cause the apparatus to associate at least one of the cell identification or the tracking area code with the discovery signal by associating at least a portion of a physical cell identity with the discovery signal.

13. A method comprising:
receiving a discovery signal from another device that seeks to establish communications;
determining, with a processor, whether a predetermined cell identification or a predetermined tracking area code is associated with the discovery signal;
in an instance in which a predetermined cell identification or a predetermined tracking area code is associated with the discovery signal, causing the predetermined cell identification or the predetermined tracking area code to be provided from a device that will participate in device-to-device communication to a network entity to facilitate paging of another device; and
causing communications to be established with another device in response to the paging.

14. A method according to claim 13 wherein determining whether a predetermined cell identification or a predetermined tracking area code is associated with the discovery signal comprises determining whether at least a portion of the discovery signal is masked with a predetermined cell identification or a predetermined tracking area code.

15. A method according to claim 14 wherein determining whether at least a portion of the discovery signal is masked comprises determining whether a cyclic redundancy check of the discovery signal is masked with at least one of the cell identification or the tracking area code.

16. A method according to claim 14 wherein determining whether at least a portion of the discovery signal is masked comprises determining whether at least a portion of the discovery signal is masked with a masking sequence associated with at least one of a cell identification or a tracking area code.

17. A method according to claim 13 wherein determining whether a predetermined cell identification or a predetermined tracking area code is associated with the discovery signal comprises determining whether at least one of the cell identification or the tracking area code is included as data with the discovery signal.

18. A method according to claim 13 wherein determining whether a predetermined cell identification or a predetermined tracking area code is associated with the discovery signal comprises determining whether at least a portion of a physical cell identity is associated with the discovery signal.

19. An apparatus comprising:
at least one processor; and
at least one memory including computer program code, wherein the at least one memory and the computer program code are configured to, with the at least one processor, cause the apparatus to at least:
receive a discovery signal from another device that seeks to establish communications;
determine whether a predetermined cell identification or a predetermined tracking area code is associated with the discovery signal;
in an instance in which a predetermined cell identification or a predetermined tracking area code is associated with the discovery signal, cause the predetermined cell identification or the predetermined tracking area code to be provided from a device that will participate in device-to-device communication to a network entity to facilitate paging of another device; and
cause communications to be established with another device in response to the paging.

20. An apparatus according to claim 19 wherein the at least one memory and the computer program code are configured to, with the at least one processor, cause the apparatus to determine whether a predetermined cell identification or a predetermined tracking area code is associated with the discovery signal by determining whether at least a portion of the discovery signal is masked with a predetermined cell identification or a predetermined tracking area code.

21. An apparatus according to claim 20 wherein the at least one memory and the computer program code are configured to, with the at least one processor, cause the apparatus to determine whether at least a portion of the discovery signal is masked by determining whether a cyclic redundancy check of the discovery signal is masked with at least one of the cell identification or the tracking area code.

22. An apparatus according to claim 20 wherein the at least one memory and the computer program code are configured to, with the at least one processor, cause the apparatus to determine whether at least a portion of the discovery signal is masked by determining whether at least a portion of the discovery signal is masked with a masking sequence associated with at least one of a cell identification or a tracking area code.

23. An apparatus according to claim 19 wherein the at least one memory and the computer program code are configured to, with the at least one processor, cause the apparatus to determine whether a predetermined cell identification or a predetermined tracking area code is associated with the discovery signal by determining whether at least one of the cell identification or the tracking area code is included as data with the discovery signal.

24. An apparatus according to claim 19 wherein the at least one memory and the computer program code are configured to, with the at least one processor, cause the apparatus to determine whether a predetermined cell identification or a predetermined tracking area code is associated with the discovery signal by determining whether at least a portion of a physical cell identity is associated with the discovery signal.
